(19) United States
(12) Patent Application Publication
(10) Pub. No.: US 2026/0331128 A1
(43) Pub. Date: Oct. 22, 2026

(54) ELECTRONIC APPARATUS FOR SEPARATING AUDIO OBJECTS INCLUDED IN AN AUDIO SIGNAL, METHOD FOR OPERATING THEREOF AND STORAGE MEDIUM

(71) Applicant: SAMSUNG ELECTRONICS CO., LTD., Suwon-si (KR)

(72) Inventors: Dongwoo KIM, Suwon-si (KR); Hanki KIM, Suwon-si (KR); Sunmin KIM, Suwon-si (KR)

(73) Assignee: SAMSUNG ELECTRONICS CO., LTD., Suwon-si (KR)

(21) Appl. No.: 19/631,029

(22) Filed: Mar. 27, 2026

Related U.S. Application Data
(63) Continuation of application No. PCT/KR2026/002794, filed on Feb. 13, 2026.

(30) Foreign Application Priority Data
Apr. 21, 2025 (KR) 10-2025-0051600

(51) Int. Cl. G10L 25/84; G10L 17/02; G10L 21/0272; G10L 25/30

(52) U.S. Cl. CPC G10L 25/84; G10L 17/02; G10L 21/0272; G10L 25/30

(57) ABSTRACT

An electronic apparatus includes at least one processor and memory storing instructions, where the instructions, when executed by the at least one processor individually or collectively, cause the electronic apparatus to obtain at least one first audio object mask corresponding to a first audio frame among a plurality of audio frames, identify at least one second audio object mask corresponding to a second audio frame that is after the first audio frame by inputting the obtained at least one first audio object mask into a first neural network model and identify at least one second audio object in the second audio frame based on the identified at least one second audio object mask.

### CROSS-REFERENCE TO RELATED APPLICATION(S)

This application is a continuation application, claiming priority under 35 U.S.C. § 365(c), of an International application No. PCT/KR2026/002794, filed on Feb. 13, 2026, which is based on and claims the benefit of a Korean patent application number 10-2025-0051600, filed on Apr. 21, 2025, in the Korean Intellectual Property Office, the disclosure of which is incorporated by reference herein in its entirety.

### BACKGROUND

### 1. Field

The present disclosure relates to an electronic apparatus, a method for operating an electronic apparatus, and a storage medium, and more particularly, to an electronic apparatus for separating audio objects included in an audio signal, a method for operating an electronic apparatus, and a storage medium.

### 2. Description of Related Art

Various types of electronic devices have been developed and distributed due to the development of electronic technologies. As artificial intelligence technologies advance, various technologies are being proposed for separating at least one audio object included in an audio signal by using an artificial intelligence model. For example, technologies are being developed to separate a human speech and background sound or to separate sounds of various instruments in music.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of the disclosure, an electronic apparatus may include at least one processor and memory storing instructions, where the instructions, when executed by the at least one processor individually or collectively, cause the electronic apparatus to obtain at least one first audio object mask corresponding to a first audio frame among a plurality of audio frames, identify at least one second audio object mask corresponding to a second audio frame that is after the first audio frame by inputting the obtained at least one first audio object mask into a first neural network model and identify at least one second audio object in the second audio frame based on the identified at least one second audio object mask.

The first neural network model may be configured to, based on at least one object mask corresponding to an audio frame in a first playback section being input into the first neural network model, output at least one object mask corresponding to an audio frame that is in a second playback section after the first playback section by using a state space model.

The electronic apparatus may include a speaker, and the instructions, when executed by the at least one processor individually or collectively, may further cause the electronic apparatus to stream an audio signal including the plurality of audio frames through the speaker in real time.

The instructions, when executed by the at least one processor individually or collectively, may further cause the electronic apparatus to perform pre-processing on the first audio frame and obtain the at least one first audio object mask by inputting the pre-processed first audio frame into a second neural network model.

The instructions, when executed by the at least one processor individually or collectively, may further cause the electronic apparatus to convert the first audio frame into information about a frequency domain, normalize the information about the frequency domain, and obtain the at least one first audio object mask by inputting the normalized information into the second neural network model.

The second neural network model may be configured to, based on a pre-processed audio frame being input into the second neural network model, output at least one object mask corresponding to each of at least one audio object in the input pre-processed audio frame, and is implemented as a U-Net structure including an encoder and a decoder.

Th instructions, when executed by the at least one processor individually or collectively, may further cause the electronic apparatus to perform pre-processing for the second audio frame, perform an operation using the pre-processed second audio frame for each of the at least one second audio object mask by multiplying the pre-processed second audio frame by each of at least one second audio object mask, and identify each of the at least one second audio object based on a result of the operation.

The instructions, when executed by the at least one processor individually or collectively, may further cause the electronic apparatus to identify the at least one second audio object mask by inputting the at least one first audio object mask into the first neural network model while the first audio frame is streamed and identify at least one third audio object mask corresponding to a third audio frame that is after the second audio frame among the plurality of audio frames by inputting the identified at least one second audio object mask into the first neural network model while the second audio frame is streamed.

The instructions, when executed by the at least one processor individually or collectively, may further cause the electronic apparatus to provide a user interface (UI) including information about each of the identified at least one second audio object.

According to an aspect of the disclosure, a method of operating an electronic apparatus may include obtaining at least one first audio object mask corresponding to a first audio frame among a plurality of audio frames, identifying at least one second audio object mask corresponding to a second audio frame that is after the first audio frame, by inputting the obtained at least one first audio object mask into a first neural network model, and identifying at least one second audio object in the second audio frame based on the identified at least one second audio object mask.

The first neural network model may be configured to, based on at least one object mask corresponding to an audio frame played in a first playback section being input into the first neural network model, output at least one object mask corresponding to an audio frame that is in a second playback section after the first playback section by using a state space model.

The method may include streaming an audio signal including the plurality of audio frames in real time.

The obtaining of the at least one first audio object mask may include performing pre-processing on the first audio frame and obtaining the at least one first audio object mask by inputting the pre-processed first audio frame into a second neural network model.

The performing of the pre-processing for the first audio frame may include converting the first audio frame into information about a frequency domain, and normalizing the information about the frequency domain, where the obtaining of the at least one first audio object mask may include, obtaining the at least one first audio object mask by inputting the normalized information into the second neural network model.

According to an aspect of the disclosure, a non-transitory, computer readable storage medium may store instructions that, when executed by at least one processor of an electronic apparatus, cause the electronic apparatus to obtain at least one first audio object mask corresponding to a first audio frame among a plurality of audio frames, identify at least one second audio object mask corresponding to a second audio frame that is after the first audio frame by inputting the obtained at least one first audio object mask into a first neural network model, and identify at least one second audio object in the second audio frame based on the identified at least one second audio object mask.

The instructions, when executed by the at least one processor, may further cause the electronic apparatus to perform pre-processing on the first audio frame and obtain the at least one first audio object mask by inputting the pre-processed first audio frame into a second neural network model.

The instructions, when executed by the at least one processor, may further cause the electronic apparatus to convert the first audio frame into information about a frequency domain, normalize the information about the frequency domain, and obtain the at least one first audio object mask by inputting the normalized information into the second neural network model.

The instructions, when executed by the at least one processor, may cause the electronic apparatus to convert the first audio frame into information about the frequency domain by using an x-point fast Fourier transform (FFT) algorithm.

The instructions, when executed by the at least one processor, may cause the electronic apparatus to normalize the information about the frequency domain by applying per-channel energy normalization (PCEN) to the information about the frequency domain.

The instructions, when executed by the at least one processor, may further cause the electronic apparatus to perform pre-processing for the second audio frame, multiply the pre-processed second audio frame by each of at least one second audio object mask, and identify each of the at least one second audio object based on a result of the operation.

### BRIEF DESCRIPTION OF DRAWINGS

The above and other aspects, features, and advantages of certain example embodiments of the present disclosure will be more apparent from the following description taken in conjunction with the accompanying drawings.

FIG. 1 is a diagram schematically illustrating an embodiment of an electronic apparatus according to an embodiment.

FIG. 2 is a block diagram illustrating a configuration of the electronic apparatus according to an embodiment.

FIG. 3 is a flowchart illustrating a method for operating an electronic apparatus according to an embodiment.

FIG. 4 is a flowchart illustrating a method for obtaining at least one first audio object mask according to an embodiment.

FIG. 5 is a flowchart illustrating a method for obtaining at least one first audio object mask according to an embodiment.

FIG. 6 is a flowchart illustrating a method for identifying each of at least one second audio object according to an embodiment.

FIG. 7 is a flowchart illustrating a method for identifying a third audio object mask according to an embodiment.

FIG. 8 is a diagram illustrating an object mask obtaining module according to a comparative example.

FIG. 9 is a block diagram illustrating a method for obtaining an audio object according to an embodiment.

FIG. 10 is a diagram illustrating a method for outputting an audio signal including an audio object according to a comparative example.

FIG. 11 is a diagram illustrating a method for outputting an audio signal including an audio object according to an embodiment.

FIG. 12 is a block diagram illustrating a detailed configuration of an electronic apparatus according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, "at least one of a, b, and c," should be understood as including only a, only b, only c, both a and b, both a and c, both b and c, or all of a, b, and c.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the specification, an expression such as “have,” “may have,” “include,” or “may include” indicates the presence of a corresponding feature (e.g., a numerical value, a function, an operation, or a component such as a part), and does not exclude the presence of an additional feature.

Expressions such as “first” and “second” used in the present disclosure may indicate various components regardless of the sequence or importance of the components. The expression is used only to distinguish one component from another component, and does not limit the corresponding component.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “~er/~or” may perform at least one function or operation, and be implemented by hardware, software, or a combination of hardware and software. In addition, a plurality of “modules” or a plurality of “~ers/~ors” may be integrated in at least one module and be implemented by the processor except for a “module” or a “~er/or” that needs to be implemented by a specific hardware.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

In addition, in the specification, a term such as “signal” may include not only an electrical signal but also an acoustic signal, and when the signal is implemented as an electrical signal, the signal may correspond to an analog signal or a digital signal. For example, an expression such as “audio signal” (or “noise signal”) refers to an acoustic (or radio wave) signal when the signal is located outside the electronic apparatus and refers to an electrical signal when the signal is located inside the electronic apparatus. In addition, signal processing within the electronic apparatus described below may be performed not only in a digital signal processing manner but also in an analog signal processing manner or in a signal processing manner that uses a combination of analog and digital techniques.

In addition, in the specification, a term such as “filter” refers to removing a specific component (e.g., a specific frequency region or a specific pattern), and the filter may include a digital filter or an analog filter.

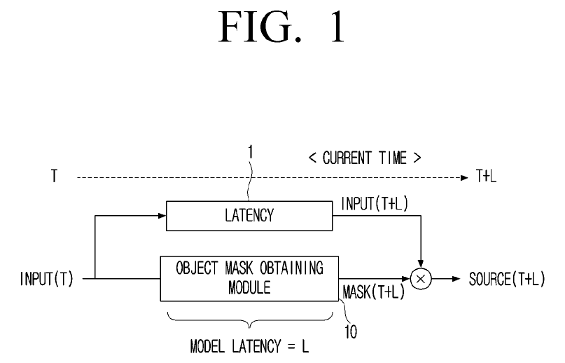

FIG. 1 is a diagram schematically illustrating a usage example of an electronic apparatus according to an embodiment.

Referring to FIG. 1, an electronic apparatus 100 according to an example may include an object mask obtaining module 10 (or an audio object mask obtaining module). For example, an audio object mask corresponding to an audio frame may be a mask corresponding to at least one audio object included in the audio frame. For example, an audio object may refer to an audio component (or an audio source) that may be independently identified in an audio signal. For example, the object mask obtaining module 10 may output an audio object mask corresponding to a second time point after a first time point from an audio frame at the first time point by using a trained neural network model.

For example, “Input(t)” may correspond to an audio signal at a time point “t” (or an audio signal currently being played). The audio signal at the time point “t” may correspond to an audio frame corresponding to the time point “t.” A “Latency” block 1 may indicate that, after “Input(t)” is obtained, an audio signal “Input(t+l)” corresponding to a time point “t+l” is obtained after a latency l corresponding to the object mask obtaining module 10 elapses.

For example, when the audio signal “Input(t)” at the time point “t” is input, the object mask obtaining module 10 may output an audio object mask “Mask(t+l)” corresponding to the audio signal at the time point “t+l.” In other words, the object mask obtaining module 10 may output the audio object mask “Mask(t+l)” corresponding to an audio signal scheduled to be output at a future time point from the audio signal currently being played.

For example, the electronic apparatus 100 may obtain an audio object Source(t+l) for the audio signal corresponding to the time point “t+l” by performing an operation on the audio signal “Input(t+l)” corresponding to the time point “t+l” and the audio object mask “Mask(t+l)” corresponding to the audio signal at the time point “t+l.” For example, when the playback of the audio signal at time point “t” is completed, the electronic apparatus 100 may immediately play the audio signal at time point “t+l” as a separate audio object (Source(t+l)).

Hereinafter, various embodiments in which audio without delay (or minimized delay) is provided by predicting an audio object mask for an audio signal at a future time point and an operation is performed on the predicted audio object mask and the audio signal at the future time point are described.

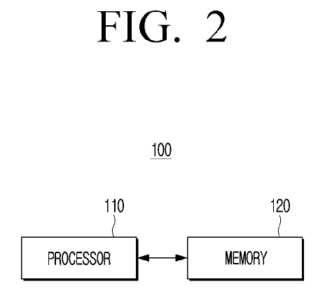

FIG. 2 is a block diagram illustrating a configuration of the electronic apparatus according to an embodiment.

Referring to FIG. 2, an electronic apparatus 100 may include at least one processor 110 and memory 120.

For example, the electronic apparatus 100 may be implemented as a television (TV). Alternatively, the electronic apparatus 100 may be implemented as a user terminal (e.g., a smartphone or a tablet personal computer (PC)). However, the present disclosure is not limited thereto, and the electronic apparatus 100 may be implemented as different types of electronic apparatuses for computing, processing, or storing data.

At least one processor 110 (hereinafter, a processor) may be electrically connected to the memory 120 and control overall operations of the electronic apparatus 100. The processor 110 may include one or more processors. In detail, the processor 110 may perform operations of the electronic apparatus 100 according to various embodiments of the present disclosure by executing at least one instruction stored in the memory 120.

According to an embodiment, the processor 110 may be implemented as a digital signal processor (DSP) for processing digital video signals, a microprocessor, a graphics processing unit (GPU), an artificial intelligence (AI) processor, a neural processing unit (NPU), or a time controller (TCON). However, the present disclosure is not limited thereto, and the processor 110 may include one or more of a central processing unit (CPU), a micro controller unit (MCU), a micro processing unit (MPU), a controller, an application processor (AP), a communication processor (CP), or an advanced RISC machine (ARM) processor, or may be defined by the corresponding term. In addition, the processor 110 may be implemented as a system-on-chip (SoC) or large scale integration (LSI) with a built-in processing algorithm, or may be implemented as an application specific integrated circuit (ASIC) or a field programmable gate array (FPGA).

The memory 120 may store data required for various embodiments. The memory 120 may be implemented as memory embedded in the electronic apparatus 100 depending on a data storage purpose or may be implemented as memory detachable from the electronic apparatus 100. For example, data for driving the electronic apparatus 100 may be stored in the memory embedded in the electronic apparatus 100, and data for extended functions of the electronic apparatus 100 may be stored in the memory detachable from the electronic apparatus 100.

The memory embedded in the electronic apparatus 100 may be implemented as at least one of: volatile memory (e.g., dynamic random access memory (DRAM), static RAM (SRAM), or synchronous dynamic RAM (SDRAM)); or non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), a hard drive, or a solid state drive (SSD)). In addition, the memory detachable from the electronic apparatus 100 may be implemented as a memory card (e.g., compact flash (CF), secure digital (SD), micro secure digital (Micro-SD), mini secure digital (Mini-SD), extreme digital (xD), or a multi-media card (MMC)) or external memory connectable to a universal serial bus (USB) port (e.g., USB memory).

According to an embodiment, the processor 110 may obtain an audio object mask corresponding to an audio frame. For example, the processor 110 may obtain an audio signal including a plurality of audio frames. For example, an audio frame may correspond to audio information having a predetermined time duration. For example, the predetermined time duration may be 10.6 milliseconds (ms). However, the present disclosure is not limited thereto, and the audio frame may have a different time duration.

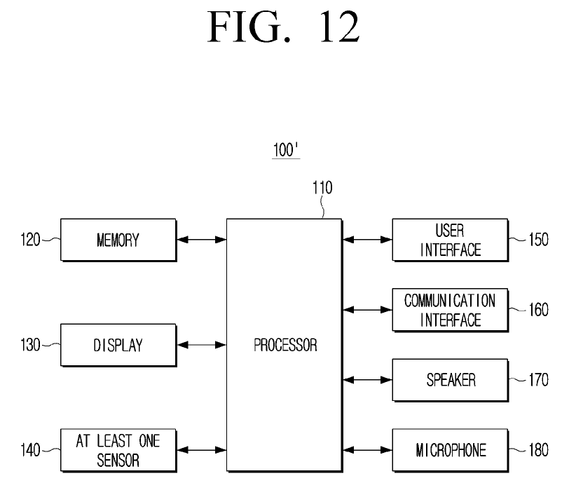

For example, the audio signal may correspond to data transmitted in real time from an external device (e.g., an external server). For example, the processor 110 may obtain the audio signal in real time from the external device through a communication interface (e.g., a communication interface 160 illustrated in FIG. 12).

For example, the processor 110 may stream the audio signal including the plurality of audio frames through a speaker (e.g., a speaker 170 in FIG. 12) in real time. For example, the processor 110 may periodically obtain the audio frame and may stream the audio signal in real time by outputting the obtained audio frame through the speaker. However, the present disclosure is not limited thereto.

For example, at least one audio object may be included in the audio frame. For example, an audio object may refer to an audio component (or an audio source) that may be independently identified in an audio signal. For example, the audio frame may include an audio object corresponding to a human speech and an audio object corresponding to background sound. However, the present disclosure is not limited thereto, and the audio frame may include audio objects of different types. For example, the audio frame corresponding to music may include audio objects corresponding to each of a plurality of instruments.

For example, an audio object mask corresponding to an audio frame may be a mask corresponding to at least one audio object included in the audio frame. For example, the audio object may correspond to an algorithm (or a value output by the algorithm) for estimating magnitude spectra corresponding to each of a plurality of audio objects included in an audio signal, to separate the audio signal including the plurality of audio objects. For example, the audio object mask may be a mask corresponding to each audio object included in the audio frame. However, the present disclosure is not limited thereto, and the number of audio object masks and the number of audio objects are not necessarily required to match each other.

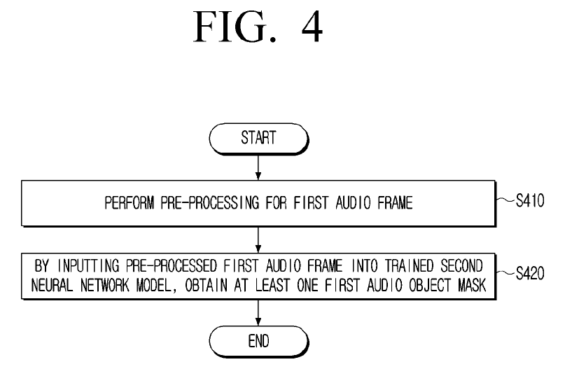

For example, the processor 110 may obtain at least one first audio object mask corresponding to a first audio frame among a plurality of audio frames. For example, when the first audio frame among the plurality of audio frames included in the audio signal is obtained, the processor 110 may identify at least one first audio object corresponding to the first audio frame. The processor 110 may obtain at least one first audio object mask corresponding to the identified at least one first audio object by using a predetermined algorithm. Details thereof will be described with reference to FIG. 4.

According to an embodiment, the processor 110 may identify a second audio object mask corresponding to a second audio frame that is played after the first audio frame, based on the first audio object mask. For example, the second audio frame may be an audio frame included in the plurality of audio frames. For example, at least one second audio object mask may be a mask corresponding to a second audio object included in the second audio frame.

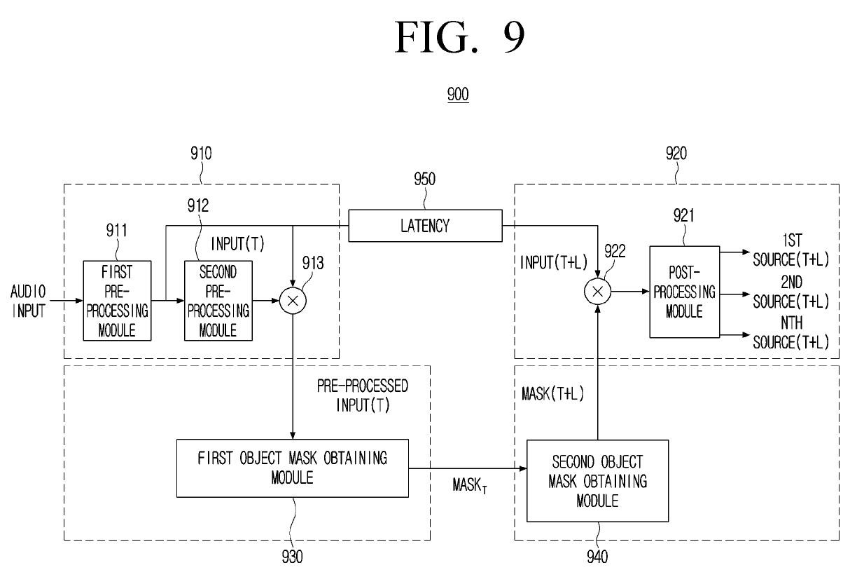

For example, by inputting the obtained at least one first audio object mask into a trained first neural network model, the processor 110 may identify at least one second audio object mask corresponding to the second audio frame. For example, the trained first neural network model may be a model trained to, based on at least one object mask corresponding to an audio frame played in a first playback section being input, output at least one object mask corresponding to an audio frame that is played in a second playback section after the first playback section by using a state space model. For example, the state space model may be a model for estimating a future state from a current state by using a state estimation equation. For example, the trained first neural network model may include a block (or a mamba block) implemented as an optional state space model. However, the present disclosure is not limited thereto. Details of the first neural network model will be described with reference to FIG. 9.

For example, the first neural network model may be trained using pairs of temporally consecutive audio object masks. Specifically, during training, the first neural network model may receive an audio object mask corresponding to a current audio frame as an input, and may be trained to output an audio object mask corresponding to a future audio frame that is temporally subsequent to the current audio frame. The training may be performed by minimizing a loss function, such as a mean squared error (MSE) loss or an L1 loss, between the predicted audio object mask for the future audio frame and a ground truth audio object mask for the future audio frame. For example, the ground truth audio object mask for the future audio frame may be obtained by inputting the future audio frame into the second neural network model.

For example, when at least one first audio object mask corresponding to the first audio frame currently being streamed is identified, the processor 110 may input the identified first audio object mask into the trained first neural network model. For example, when at least one audio object mask is output from the trained first neural network model, the processor 110 may identify the output audio object mask as at least one second audio object mask corresponding to the second audio frame.

According to an embodiment, the processor 110 may identify the second audio object based on at least one second audio object mask. For example, the processor 110 may identify each of at least one second audio object included in the second audio frame based on the identified at least one second audio object mask.

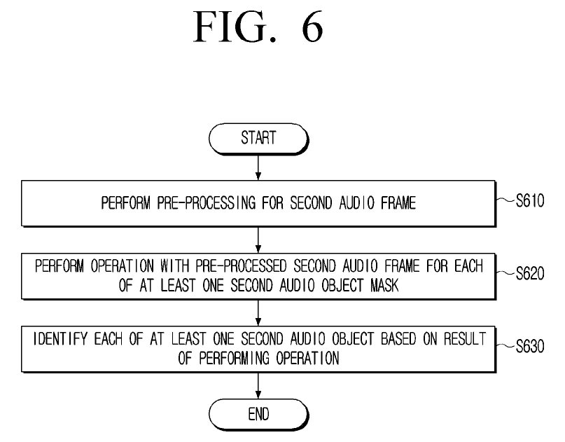

For example, the processor 110 may identify at least one second audio object by performing an operation on the second audio frame and at least one second audio object mask. For example, the processor 110 may identify each second audio object by performing an operation with the second audio frame for each of at least one second audio object mask. Details thereof will be described with reference to FIG. 6.

According to an embodiment, the processor 110 may provide a user interface (UI) including information about each of the identified at least one second audio object. For example, the processor 110 may provide a UI for controlling any one of the second audio objects. For example, the processor 110 may obtain, through the UI, a user input that causes an output value of any one audio object among at least one second audio object to become zero. The processor 110 may control an output of at least one second audio object based on the obtained user input.

According to the above-described example, the electronic apparatus may obtain an audio object mask for an audio frame to be provided in the future by using an audio object mask for an audio frame currently being provided, and may identify at least one audio object included in the audio frame to be provided in the future. Accordingly, the electronic apparatus may prevent a situation in which audio playback is delayed due to latency occurring in an audio separation process, and may provide a stable audio separation function even when audio is streamed in real time.

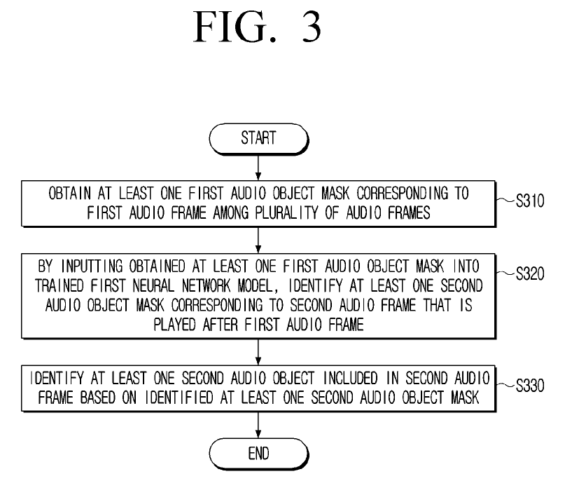

FIG. 3 is a flowchart illustrating a method for operating an electronic apparatus 100 according to an embodiment.

Referring to FIG. 3, the method for operating an electronic apparatus according to an embodiment may include an operation (S310) of obtaining at least one first audio object mask corresponding to the first audio frame among the plurality of audio frames.

For example, the electronic apparatus 100 may obtain the plurality of audio frames. For example, the electronic apparatus 100 may obtain at least one first audio object mask corresponding to the first audio frame among the plurality of audio frames by using a predetermined algorithm.

According to an embodiment, the method for operating an electronic apparatus according to an embodiment may include an operation (S320) of, by inputting the obtained at least one first audio object mask into the trained first neural network model, identifying at least one second audio object mask corresponding to the second audio frame that is played after the first audio frame.

For example, the electronic apparatus 100 may input the obtained at least one first audio object mask into the trained first neural network model. For example, when at least one audio object mask is output from the first neural network model, the electronic apparatus 100 may identify the output audio object mask as the second audio object mask corresponding to the second audio frame.

The method for operating an electronic apparatus according to an embodiment may include an operation (S330) of identifying at least one second audio object included in the second audio frame based on the identified at least one second audio object mask.

For example, when at least one second audio object mask is identified, the electronic apparatus 100 may identify at least one second audio object included in the second audio frame based on the identified at least one second audio object mask.

FIG. 4 is a flowchart illustrating a method for obtaining at least one first audio object mask according to an embodiment.

Referring to FIG. 4, the method for operating an electronic apparatus according to an embodiment may include an operation (S410) of performing pre-processing for the first audio frame.

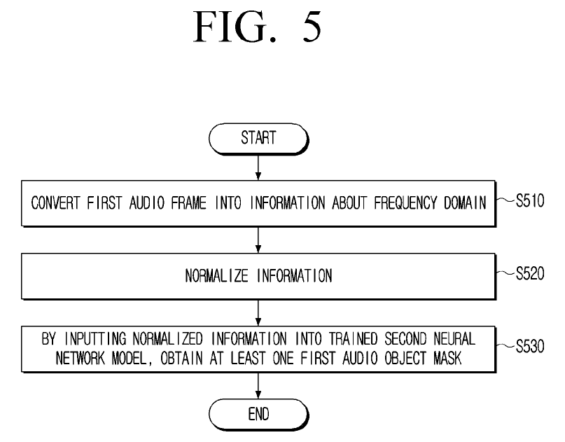

For example, the electronic apparatus 100 may perform pre-processing for the first audio frame. For example, the electronic apparatus 100 may convert the audio signal including the first audio frame into information about a frequency domain by using a predetermined algorithm and may obtain a pre-processed first audio frame by normalizing the converted information. Details thereof will be described with reference to FIG. 5.

The method for operating an electronic apparatus according to an embodiment may include an operation (S420) of, by inputting the pre-processed first audio frame into the trained second neural network model, obtaining at least one first audio object mask.

For example, when the pre-processing operation for the first audio frame is completed, the electronic apparatus 100 may, by inputting the pre-processed first audio frame into the trained second neural network model, obtain at least one first audio object mask.

For example, the second neural network model may be a model trained to, based on the pre-processed audio frame being input, output at least one object mask corresponding to at least one audio object included in the input audio frame. For example, unlike the first neural network model trained to output the audio object mask corresponding to an audio frame at a future time point, the second neural network model may be a model trained to output an audio object mask corresponding to the input audio frame. For example, the second neural network model may be a different type of neural network model outputting a mask corresponding to at least one audio object included in the audio signal.

For example, the second neural network model may be trained using pairs of mixed audio signals and corresponding individual source audio signals. During training, the second neural network model may receive a pre-processed mixed audio frame as an input, and may be trained to output audio object masks that, when applied to the mixed audio frame, reconstruct the individual source audio signals. The training may be performed by minimizing a loss function between the reconstructed audio signals and the ground truth source audio signals.

For example, the second neural network model may be implemented in a U-Net structure including an encoder and a decoder. The U-Net structure is a symmetric neural network structure including a contracting path and an expanding path and may correspond to a structure used for separating an audio signal in which a plurality of audio objects are mixed. For example, an encoder included in the second neural network model may be implemented as a 1-dimensional CNN (1D CNN) block that extracts frequency components of input data by performing convolution only on a frequency axis. For example, a decoder included in the second neural network model may be implemented as a 1-dimensional transposed CNN (1D TrCNN) block that restores output data to an original size through upsampling on the frequency axis.

For example, the trained second neural network model may include a block implemented as an optional state space model (or a mamba block). The mamba block is a neural network block implemented as an optional state space model and may be trained to predict a future state from input data corresponding to a current state. The mamba block may selectively process data by dynamically adjusting (or changing) parameters based on the input data. The mamba block has a recursive structure and may perform fast and efficient processing as time complexity increases linearly. However, the present disclosure is not limited thereto, and the second neural network model may be implemented as a neural network block of a type different from the mamba block.

FIG. 5 is a flowchart illustrating a method for obtaining at least one first audio object mask according to an embodiment.

Referring to FIG. 5, the method for operating an electronic apparatus according to an embodiment may include an operation (S510) of converting the first audio frame into the information about the frequency domain.

For example, the electronic apparatus 100 may convert the audio signal including the first audio frame into information about the frequency domain by using a predetermined algorithm. For example, the electronic apparatus 100 may convert the audio signal into the data of the frequency domain by using an x-point fast Fourier transform (FFT) algorithm. However, the present disclosure is not limited thereto, and a different type of algorithm for converting the audio signal into the data of the frequency domain may also be used.

The method for operating an electronic apparatus according to an embodiment may include an operation (S520) of normalizing the converted information.

For example, the electronic apparatus 100 may normalize the audio signal converted into the data (or, information) of the frequency domain. For example, the electronic apparatus 100 may obtain normalized data by applying per-channel energy normalization (PCEN) to the converted data. However, the present disclosure is not limited thereto, and a different normalization algorithm may also be used.

The method for operating an electronic apparatus according to an embodiment may include an operation (S530) of, by inputting the normalized information into the trained second neural network model, obtaining at least one first audio object mask.

For example, the electronic apparatus 100 may input the normalized data into the trained second neural network model. For example, the normalized data may be data of a complex number type and may be two-dimensional data including real values and imaginary values. The electronic apparatus 100 may obtain at least one first audio object mask by inputting the normalized first audio frame into the trained second neural network model.

FIG. 6 is a flowchart illustrating a method for identifying each of the second audio objects according to an embodiment.

Referring to FIG. 6, the method for operating an electronic apparatus according to an embodiment may include an operation (S610) of performing pre-processing for the second audio frame.

For example, the electronic apparatus 100 may perform pre-processing for the second audio frame. For example, the electronic apparatus 100 may convert the audio signal including the second audio frame into the data of the frequency domain by using a predetermined algorithm. For example, the electronic apparatus 100 may convert the audio signal into the data of the frequency domain by using an x-point fast Fourier transform (FFT) algorithm. However, the present disclosure is not limited thereto, and a different type of algorithm for converting the audio signal into the data of the frequency domain may also be used.

The method for operating an electronic apparatus according to an embodiment may include an operation (S620) of performing an operation with the pre-processed second audio frame for each of at least one second audio object mask.

For example, the electronic apparatus 100 may perform an operation with the pre-processed second audio frame for each of at least one second audio object mask obtained using the trained first neural network model. For example, the audio object mask may be the data of the frequency domain, and the pre-processed second audio frame may also be the data of the frequency domain.

For example, when each of at least one second audio object mask and the pre-processed second audio frame is the data of the frequency domain, the electronic apparatus 100 may obtain at least one second audio object included in the second audio frame by multiplying the pre-processed second audio frame by each of at least one second audio object mask. However, the present disclosure is not limited thereto, and a different type of operation may also be performed.

The method for operating an electronic apparatus according to an embodiment may include an operation (S630) of identifying each of at least one second audio object based on a result of performing the operation.

For example, the electronic apparatus 100 may obtain the data of the frequency domain corresponding to each of at least one second audio object by performing an operation with the pre-processed second audio frame for each of at least one second audio object mask. For example, the electronic apparatus 100 may obtain at least one second audio object by applying an inverse fast Fourier transform (inverse FFT) algorithm to the data of the frequency domain corresponding to each of at least one second audio object. However, the present disclosure is not limited thereto, and a different type of algorithm for converting the data of the frequency domain into data of a time domain may also be used.

For example, even when an operation is performed on each of at least one second audio object mask and the second audio frame, the number of second audio objects finally obtained by the electronic apparatus 100 may be different from the number of second audio object masks. The reason is that a single mask (or object mask) may be used to obtain a plurality of audio objects, and a plurality of masks may be used to obtain a single audio object.

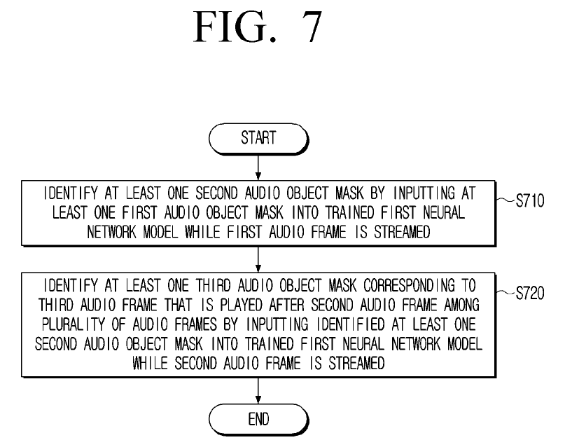

FIG. 7 is a flowchart illustrating a method for identifying a third audio object mask according to an embodiment.

Referring to FIG. 7, the method for operating an electronic apparatus according to an embodiment may include an operation (S710) of identifying at least one second audio object mask by inputting at least one first audio object mask into the trained first neural network model while the first audio frame is streamed.

For example, the electronic apparatus 100 may obtain an audio signal including the first audio frame and the second audio frame from an external device. For example, the electronic apparatus 100 may sequentially obtain the first audio frame and the second audio frame from the external device.

For example, while the electronic apparatus 100 obtains and streams the first audio frame, the electronic apparatus 100 may obtain at least one first audio object mask corresponding to the first audio frame by inputting the obtained first audio frame into the trained second neural network model.

For example, the electronic apparatus 100 may identify at least one second audio object mask corresponding to the second audio frame that is to be streamed after the first audio frame by inputting the obtained at least one first audio object mask into the trained first neural network model.

For example, a duration of the audio frame may be 10.6 milliseconds (ms), and a time (or latency) required for the electronic apparatus 100 to obtain at least one second audio object mask from the first audio frame may be between 6 ms and 10 ms. Accordingly, the electronic apparatus 100 may obtain the second audio object mask corresponding to the second audio frame to be played after the first audio frame before playback of the first audio frame is completed, and the electronic apparatus 100 may separate the second audio frame into at least one audio object by using the second audio object mask. Accordingly, a delay that may occur due to latency may be prevented.

The method for operating an electronic apparatus according to an embodiment may include an operation (S720) of identifying at least one third audio object mask corresponding to a third audio frame that is played after the second audio frame among the plurality of audio frames by inputting the identified at least one second audio object mask into the trained first neural network model while the second audio frame is streamed.

For example, while the second audio frame is streamed after streaming of the first audio frame is completed, the electronic apparatus 100 may input the identified at least one second audio object mask into the trained first neural network model. For example, the electronic apparatus 100 may identify at least one third audio object mask corresponding to the third audio frame based on output data obtained from the first neural network model. Similarly, the electronic apparatus 100 may obtain the third audio object mask corresponding to the third audio frame to be played after the second audio frame before playback of the second audio frame is completed. The electronic apparatus 100 may separate the third audio frame into at least one audio object by using the third audio object mask. Accordingly, a delay that may occur due to latency may be prevented.

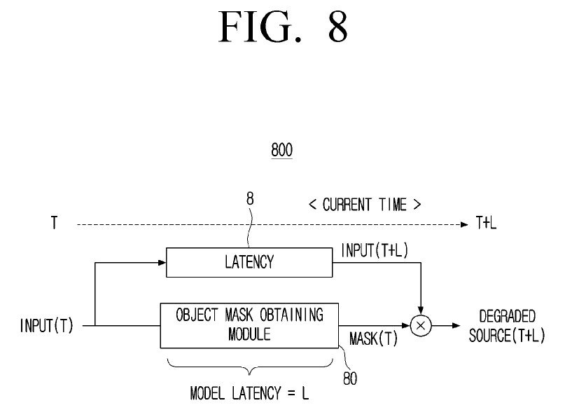

FIG. 8 is a diagram illustrating an object mask obtaining module according to a comparative example.

Referring to FIG. 8, an electronic apparatus 800 according to a comparative example may include an object mask obtaining module 80. “Input(t)” may correspond to an audio signal at a time point “t” (or an audio signal currently being played). The audio signal at the time point “t” may correspond to an audio frame corresponding to the time point “t.” A “Latency” block 8 may indicate that, after “Input(t)” is obtained, an audio signal “Input(t+l)” corresponding to a time point “t+l” is obtained after a latency l corresponding to the object mask obtaining module 80 elapses.

When the audio signal “Input(t)” at the time point “t” is input, the object mask obtaining module 80 may output an audio object mask “Mask(t)” corresponding to the audio signal at the time point “t.” In other words, the object mask obtaining module 80 may output the audio object mask “Mask(t)” corresponding to the audio signal currently being played at the time point “t+l” (i.e., as opposed to Mask(t+l) as shown in FIG. 1).

For example, the electronic apparatus 100 according to the present disclosure may output an audio object mask corresponding to an audio frame at a future time point by using the trained first neural network model and the trained second neural network model. In contrast, the electronic apparatus 800 according to the comparative example may obtain an audio object “Degraded Source(t+l)” for the audio signal corresponding to the time point “t+l” by performing an operation on the audio signal “Input(t+l)” corresponding to the time point “t+l” and the audio object mask “Mask(t)” corresponding to the audio signal at the time point “t.”

As in the comparative example, when synchronization between the input audio signal and the audio object mask does not match, separation performance of the audio signal may be degraded. That is, when the electronic apparatus 800 according to the comparative example is implemented as a multimedia streaming device in which synchronization between video and audio is important, such as a TV, it may be difficult for the electronic apparatus 800 to use the above-described audio separation model.

In contrast, the present disclosure may predict an audio object mask for an audio signal at a future time point (e.g., a time point after a latency elapses or a time point after a time point corresponding to an audio frame elapses), and the predicted audio object mask may then be used to perform an operation on the audio signal at the future time point. Accordingly, synchronization between the input audio signal and the audio object mask may match each other, thereby preventing separation performance of the audio signal from being degraded.

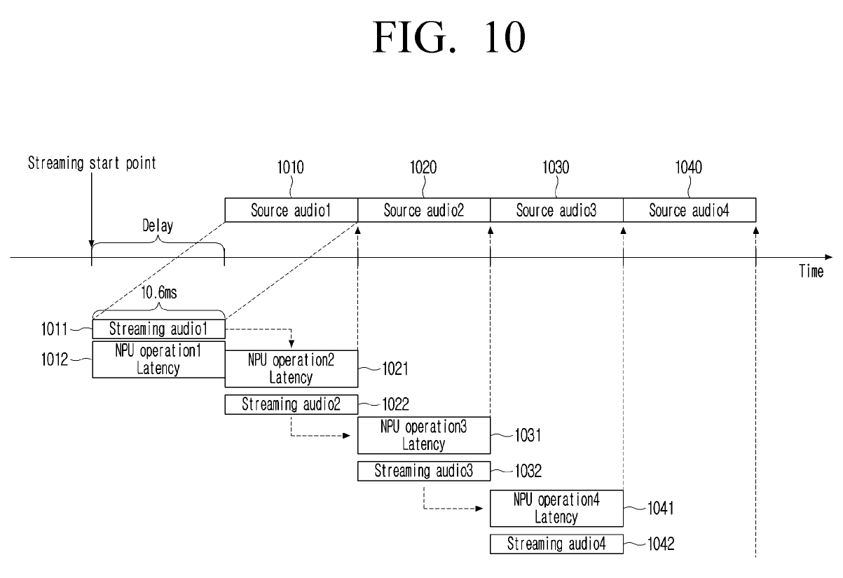

Unlike as illustrated in FIG. 8, when the model is implemented to match synchronization between the audio signal and the audio object mask, a delay may occur due to the latency corresponding to the object mask obtaining module. Details thereof will be described with reference to FIG. 10.

FIG. 9 is a block diagram illustrating a method for obtaining an audio object according to an embodiment.

Referring to FIG. 9, an electronic apparatus 900 according to an embodiment (e.g., the electronic apparatus 100 in FIG. 2) may include a first module 910 that performs a pre-processing operation, a first object mask obtaining module 930, a second object mask obtaining module 940, and a second module 920 that performs a post-processing operation. For example, “Audio input” may be an audio signal obtained by the electronic apparatus 900. For example, an audio signal at the time point “t” (or an audio signal currently being played) may be an audio frame corresponding to the time point “t.”

For example, the first module 910 may include a first pre-processing module 911 and a second pre-processing module 912. For example, the first pre-processing module 911 may be a module that converts an audio signal including an audio frame into data of a frequency domain by using a predetermined algorithm. For example, the first pre-processing module 911 may convert the audio signal into the data of the frequency domain by using an x-point FFT (fast Fourier transform) algorithm. For example, the second pre-processing module 912 may be a module that normalizes an audio signal converted into data of a frequency domain. For example, the second pre-processing module 912 may output normalized data by applying Per-Channel Energy Normalization (PCEN) to the converted data.

For example, “Input(t)” may be information corresponding to an audio signal at the time point “t,” and may be information converted into a frequency domain through the first pre-processing module 911. For example, an operation symbol 913 may be a symbol indicating that an audio signal is pre-processed through the first pre-processing module 911 and the second pre-processing module 912.

For example, the first module 910 may pre-process the audio frame corresponding to the time point “t” through the first pre-processing module 911 and the second pre-processing module 912. For example, the first module 910 may transmit the pre-processed audio frame “Pre-processed Input(t)” to the first object mask obtaining module 930. In other words, “Input(t)” may be information converted into data of the frequency domain through the first pre-processing module 911, and “pre-processed Input(t)” may be information in which “Input(t)” is normalized through the second pre-processing module 912.

For example, when the pre-processed audio frame “Pre-processed Input(t)” is input, the first object mask obtaining module 930 may output the audio object mask “Mask(t)” corresponding to the audio frame at the time point “t” based thereon. For example, the first object mask obtaining module 930 may be implemented as the trained second neural network model. For example, the first object mask obtaining module 930 may be a model trained to output at least one object mask corresponding to at least one audio object included in the input audio frame when the pre-processed audio frame is input. For example, the first object mask obtaining module 930 may transmit the audio object mask “Mask(t)” corresponding to the audio frame at the time point “t” to the second object mask obtaining module 940.

For example, the second object mask obtaining module 940 may be implemented as the trained first neural network model. For example, the second object mask obtaining module 940 may be a model trained to, based on at least one object mask corresponding to an audio frame played in the first playback section being input, output at least one object mask corresponding to the audio frame that is played in the second playback section after the first playback section by using the state space model. For example, the second object mask obtaining module 940 may include a mamba block.

For example, when the audio object mask “Mask(t)” corresponding to the audio frame at the time point “t” is obtained, the second object mask obtaining module 940 may output at least one audio object mask “Mask(t+l)” corresponding to the audio frame at the time point “t+l” based thereon. For example, the time point “t+l” may be a time point at which the latency “l” caused by an operation of the first module 910, the first object mask obtaining module 930, or the second object mask obtaining module 940 has elapsed from the audio time point “t.” For example, the second object mask obtaining module 940 may transmit the audio object mask “Mask(t+l)” corresponding to the audio frame at the time point “t+l” to the second module 920.

For example, a “Latency” block 950 may be a block indicating that the audio signal “Input(t+l)” is obtained at the time point “t+l” at which the latency “l” has elapsed. For example, “Input(t+l)” may be information corresponding to the audio signal at the time point “t+l,” and may be information in which the audio signal at the time point “t+l” is converted into the frequency domain through the first pre-processing module 911. For example, the audio signal at “t+l” may be an audio frame corresponding to the time point “t+l.”

For example, the second module 920 may obtain the data of the frequency domain corresponding to each of at least one audio object at the time point “t+l” by performing an operation on “Input(t+l)” and at least one audio object mask “Mask(t+l)” corresponding to the time point “t+l.”

For example, an operation symbol 922 may be a symbol indicating that an operation is performed on “Input(t+l)” corresponding to the time point “t+l” and at least one audio object mask “Mask(t+l)” corresponding to the time point “t+l.” For example, when the audio object mask is the data of the frequency domain and the pre-processed second audio frame is also the data of the frequency domain, the electronic apparatus 900 may obtain the data of the frequency domain corresponding to each of at least one audio object by multiplying “Input(t+l)” by each of at least one audio object mask “Mask(t+l)” corresponding to the time point “t+l.”

For example, the second module 920 may include a post-processing module 921. For example, the post-processing module 921 may obtain at least one audio object (e.g., 1st Source(t+l), 2nd Source(t+l), …, Nth Source(t+l)) for the audio frame corresponding to the time point “t+l” by applying an inverse fast Fourier transform (FFT) algorithm to the data of the frequency domain corresponding to each of at least one audio object at the time point “t+l.”

FIG. 10 is a diagram illustrating a method for outputting an audio signal including an audio object according to the comparative example.

Referring to FIG. 10, the electronic apparatus according to the comparative example may output an audio signal. When a first audio frame 1011 (streaming audio 1) is obtained, the electronic apparatus according to the comparative example may obtain an audio object mask 1012 corresponding to the first audio frame 1011 by using an object mask obtaining module. For example, “NPU operation 1 Latency” may indicate an operation time (or latency) for outputting the audio object mask 1012 corresponding to the first audio frame. For example, the electronic apparatus according to the comparative example may obtain first source audio 1010 (source audio 1) including the first audio object by using the audio object mask 1012. For example, the first source audio 1010 may be audio in which the first audio object is separated and provided.

Similarly, while the first source audio 1010 is streamed, when a second audio frame 1022 (streaming audio 2) is obtained, the electronic apparatus according to the comparative example may obtain an audio object mask 1021 corresponding to the second audio frame 1022 by using the object mask obtaining module. For example, “NPU operation 2 Latency” may indicate an operation time (or latency) for outputting the audio object mask 1021 corresponding to the second audio frame. For example, the electronic apparatus according to the comparative example may obtain second source audio 1020 (source audio 2) including the second audio object by using the audio object mask 1021. For example, the second source audio 1020 may be audio in which the second audio object is separated and provided.

Similarly, while the second source audio 1020 is streamed, when a third audio frame 1032 (streaming audio 3) is obtained, the electronic apparatus according to the comparative example may obtain an audio object mask 1031 corresponding to the third audio frame 1032 by using the object mask obtaining module. For example, “NPU (operation 3 Latency” may indicate an operation time (or latency) for outputting the audio object mask 1031 corresponding to the third audio frame. For example, the electronic apparatus according to the comparative example may obtain third source audio 1030 (source audio 3) including the third audio object by using the audio object mask 1031. For example, the third source audio 1030 may be audio in which the third audio object is separated and provided.

Similarly, while the third source audio 1030 is streamed, when a fourth audio frame 1042 (streaming audio 4) is obtained, the electronic apparatus according to the comparative example may obtain an audio object mask 1041 corresponding to the fourth audio frame 1042 by using the object mask obtaining module. For example, “NPU operation 4 Latency” may indicate an operation time (or latency) for outputting the audio object mask 1041 corresponding to the fourth audio frame. For example, the electronic apparatus according to the comparative example may obtain fourth source audio 1040 (source audio 4) including a fourth audio object by using the audio object mask 1041. For example, the fourth source audio 1040 may be audio in which the fourth audio object is separated and provided.

The electronic apparatus according to the comparative example may require a delay for a predetermined time to provide the first source audio 1010. For example, the electronic apparatus according to the comparative example may provide the first source audio 1010 after the latency required to obtain the first audio object elapses (or after time corresponding to a single audio frame elapses). Accordingly, streaming of source audio including the first source audio 1010, the second source audio 1020, the third source audio 1030, and the fourth source audio 1040 may be delayed.

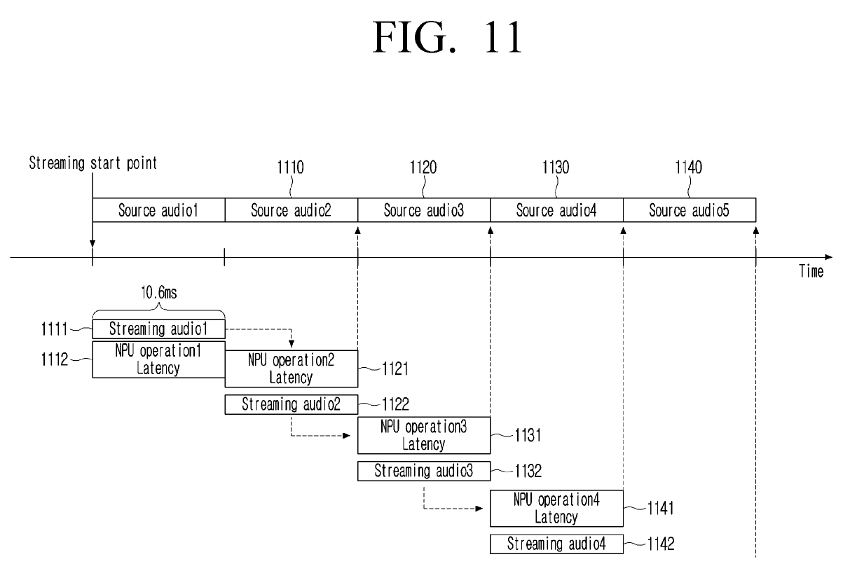

FIG. 11 is a diagram illustrating a method for outputting an audio signal including an audio object according to an embodiment.

Referring to FIG. 11, for example, the electronic apparatus 100 may output an audio signal. For example, when a first audio frame 1111 (streaming audio 1) is obtained, the electronic apparatus 100 may stream a first audio frame 1111.

For example, while the electronic apparatus 100 streams the first audio frame 1111, the electronic apparatus 100 may obtain an audio object mask 1112 corresponding to a second audio frame 1122 from the first audio frame 1111. For example, as illustrated in FIG. 9, the electronic apparatus 100 may obtain the audio object mask 1112 corresponding to the second audio frame 1122 by using a plurality of neural network models. For example, “NPU operation 1 Latency” may indicate an operation time (or latency) for outputting the audio object mask 1112 corresponding to the second audio frame 1122.

For example, the electronic apparatus 100 may obtain second source audio 1110 (source audio 2) including the second audio object corresponding to the second audio frame 1122 by using the audio object mask 1112 and the second audio frame 1122. For example, the second source audio 1110 may be audio in which the second audio object is separated and provided from the second audio frame 1122. For example, the second audio frame 1122 may be obtained before streaming of the first audio frame 1111 is completed.

For example, the electronic apparatus 100 may obtain an audio object mask 1121 corresponding to a third audio frame 1132 from the second audio frame 1122 while the second source audio 1110 is streamed. For example, as illustrated in FIG. 9, the electronic apparatus 100 may obtain the audio object mask 1121 corresponding to the third audio frame 1132 by using a plurality of neural network models. For example, “NPU operation 2 Latency” may indicate an operation time (or latency) for outputting the audio object mask 1121 corresponding to the third audio frame 1132.

For example, the electronic apparatus 100 may obtain third source audio 1120 (source audio 3) including the third audio object by using the audio object mask 1121. For example, the third source audio 1120 may be audio in which the third audio object is separated and provided from the third audio frame 1132.

For example, while the third source audio 1120 is streamed, the electronic apparatus 100 may obtain an audio object mask 1131 corresponding to a fourth audio frame 1142 from the third audio frame 1132. For example, “NPU operation 3 latency” may indicate an operation time (or latency) for outputting the audio object mask 1131 corresponding to the fourth audio frame 1142. For example, the electronic apparatus 100 may obtain fourth source audio 1130 (source audio 4) including the fourth audio object by using the audio object mask 1131. For example, the fourth source audio 1130 may be audio in which the fourth audio object is separated and provided from the fourth audio frame 1142.

Similarly, while the fourth source audio 1130 is streamed, the electronic apparatus 100 may obtain, for example, an audio object mask 1141 corresponding to a fifth audio frame. For example, “NPU operation 4 latency” may indicate an operation time (or latency) for outputting the audio object mask 1141 corresponding to the fifth audio frame. For example, the electronic apparatus 100 may obtain fifth source audio 1140 (source audio 5) including a fifth audio object by using the audio object mask 1141. For example, the fifth source audio 1140 may be audio in which the fifth audio object is separated and provided from the fifth audio frame.

According to the above-described example, unlike as illustrated in FIG. 10, the electronic apparatus 100 may provide source audio in which an audio object is separated and provided without a separate delay.

Referring again to FIG. 2, according to an embodiment, the processor 110 may provide a user interface (e.g., the user interface 150 in FIG. 12) including information about each of the identified at least one second audio object. For example, the processor 110 may provide a user interface for controlling any one of the second audio objects. For example, the processor 110 may obtain a user input through the user interface that causes an output value of any one of at least one second audio object to be 0.

For example, the processor 110 may control an output of at least one second audio object based on the obtained user input. For example, information about audio masks or audio objects identified or separated according to the present disclosure may be displayed in real time or upon user request through the user interface as selectable objects on a display.

In addition, for example, in order for the user to set or change an audio object identification function according to the present disclosure, a user interface such as a settings menu screen may be provided through the display. In addition, for example, whether to provide the information about the audio masks or the audio objects in real time or upon the user request may be set or changed based on a user input that is input through the user interface.

FIG. 12 is a block diagram illustrating a detailed configuration of an electronic apparatus according to an embodiment.

Referring to FIG. 12, an electronic apparatus 100’ may include at least one processor 110, memory 120, a display 130, at least one sensor 140, a user interface 150, the communication interface 160, the speaker 170, and a microphone 180. Descriptions of components overlapping with those illustrated in FIG. 2 may be omitted for clarity.

The display 130 may be implemented as a display including a self-light emitting element or a display including a non self-light emitting and a backlight. For example, the display 130 may be implemented as various types of displays such as a liquid crystal display (LCD), an organic light-emitting diode (OLED) display, a light-emitting diode (LED) display, a micro light-emitting diode (micro LED), a mini LED, a plasma display panel (PDP), a quantum dot (QD) display, and a quantum dot light-emitting diode (QLED) display. The display 130 may further include a driving circuit implementable as, for example an a-si thin film transistor (TFT), a low temperature poly silicon (LTPS) TFT, or an organic TFT (OTFT), and a backlight unit. The display 130 may be implemented as a touch screen combined with a touch sensor, a flexible display, a rollable display, a three-dimensional (3D) display, a display in which a plurality of display modules are physically connected to each other, or the like. The processor 110 may control the display 130 to output an output image obtained according to the various embodiments described above. Here, the output image may correspond to a high-resolution image of 4K, 8K, or higher. According to an embodiment, the output image may correspond to a game image.

According to an embodiment, the display 130 may include a plurality of haptic elements. The haptic element may be implemented as a motor for providing a user with haptic feedback (e.g., vibration feedback), and the present disclosure is not limited thereto. For example, the display 130 may include a predetermined number of haptic elements. For example, the display 130 may include a predetermined number of haptic elements corresponding to predetermined sub-regions of the display. However, the present disclosure is not limited thereto, and the number of haptic elements included in the display may be different from the number of sub-regions corresponding to the display.

At least one sensor 140 (hereinafter, “the sensor”) may include various types of sensors. The sensor 140 may measure a physical quantity or detect an operation state of the electronic apparatus 100’ and may convert the measured or detected information into an electrical signal. The sensor 140 may include a camera, and the camera may include a lens for focusing visible light and other optical signals reflected and received by an object onto an image sensor, and an image sensor for detecting visible light and other optical signals. Here, the image sensor may include a two-dimensional (2D) pixel array classified into a plurality of pixels. Alternatively, the at least one sensor 140 may include a temperature sensor or an infrared sensor.

The user interface 150 may be implemented as a configuration through which the electronic apparatus 100’ may perform interaction with a user. For example, the user interface 150 may include at least one of a touch sensor, a motion sensor, a button, a jog dial, a switch, a microphone, a speaker, or selectable objects (e.g., menus or objects) displayed on the display 130, and the present disclosure is not limited thereto.

The communication interface 160 may input and output various types of data. For example, the communication interface 160 may transmit and receive various types of data with an external device (e.g., a source device), an external storage medium (e.g., a USB memory), or an external server (e.g., a web hard) through communication methods such as wireless fidelity (Wi-Fi, wireless local area network (LAN), Bluetooth, Zigbee, wired/wireless LAN, wide area network (WAN), Ethernet, IEEE 1394, high-definition multimedia interface (HDMI), USB, mobile high-definition link (MHL), Audio engineering society/European broadcasting union (AES/EBU) communication, optical communication, or coaxial communication.

For example, the communication interface 160 may include a Bluetooth Low Energy (BLE) module. BLE refers to a Bluetooth technology for transmitting and receiving low-power and low-capacity data in a 2.4 GHz frequency band having a reach radius of approximately 10 meters. However, the present disclosure is not limited thereto, and the communication interface 160 may further include a Wi-Fi communication module. That is, the communication interface 160 may include at least one of the Bluetooth Low Energy (BLE) module and the Wi-Fi communication module.

According to an embodiment, the speaker 170 may include a tweeter for playing high-frequency sounds, a mid-range speaker for playing mid-frequency sounds, a woofer for playing low-frequency sounds, a subwoofer for playing ultra-low-frequency sounds, an enclosure for controlling resonance, a crossover network for dividing frequencies of electric signals input to the speaker for each band, or the like.

According to an embodiment, the speaker 170 may output an audio signal to the outside of the electronic apparatus 100’. The speaker 170 may output multimedia playback, recording playback, various alert notification sounds, voice messages, or the like. The electronic apparatus 100’ may include an audio output device such as the speaker 170 or may include an output device such as an audio output terminal. In particular, the speaker 170 may provide, in a voice form, information obtained, information processed and generated based on the obtained information, a response result to a user voice, an operation result, or the like.

The microphone 180 refers to a module for obtaining sound and converting the sound into an electrical signal, and may be implemented as a condenser microphone, a ribbon microphone, a moving-coil microphone, a piezoelectric microphone, a carbon microphone, or a micro electro mechanical system (MEMS) microphone. The microphone 180 may be implemented in an omnidirectional, bidirectional, unidirectional, sub-cardioid, super-cardioid, or hyper-cardioid pattern. According to an embodiment, the electronic apparatus 100’ may include the microphone 180 and an inner microphone, and the microphone 180 may be located relatively outside a user’s body. For example, the electronic apparatus 100’ may obtain an audio signal including external noise through the microphone 180. According to an embodiment, the microphone 180 may be disposed in a direction opposite to a direction in which the speaker 170 emits sound.

According to the above-described example, the electronic apparatus 100’ may obtain the audio object mask for an audio frame to be provided in the future by using the audio object mask for an audio frame currently being provided, thereby identifying at least one audio object included in the audio frame to be provided in the future. Accordingly, the electronic apparatus 100’ may prevent a situation in which audio playback is delayed due to latency occurring during the audio separation process and may provide a stable audio separation function even when audio is streamed in real time.

The methods according to the various embodiments of the present disclosure described above may be implemented in the form of an application capable of being installed on a conventional electronic apparatus. Alternatively, the methods according to the various embodiments of the present disclosure described above may be performed using a deep learning-based trained neural network (or deep trained neural network), that is, the learning network model. In addition, the methods according to the various embodiments of the present disclosure described above may be implemented only by software upgrade or hardware upgrade of the conventional electronic apparatus. In addition, the various embodiments of the present disclosure described above may be performed through an embedded server included in the electronic apparatus, or an external server of the electronic apparatus.

According to an embodiment of the present disclosure, the various embodiments described above may be implemented in software including an instruction stored in a machine-readable storage medium that may be read by a machine (e.g., computer). The machine may be a device that invokes the stored instruction from a storage medium, may be operated based on the invoked instruction, and may include a display device (e.g., display device A) according to the disclosed embodiments. When the instruction is executed by the processor, the processor may directly perform a function corresponding to the instruction, or perform the function by using other components under control of the processor. The instruction may include codes provided or executed by a compiler or an interpreter. The machine-readable storage medium may be provided in the form of a non-transitory storage medium. Here, the term “non-transitory” refers to that the storage medium is tangible without including a signal, and does not distinguish whether data are semi-permanently or temporarily stored in the storage medium.

In addition, according to an embodiment, the methods according to the various embodiments described above may be provided as being included in a computer program product. The computer program product may be traded as a product between a seller and a buyer. The computer program product may be distributed in the form of a machine-readable storage medium (e.g., a compact disc read only memory (CD-ROM)) or online through an application store (e.g., Play Store™). In the case of online distribution, at least part of the computer program product may be temporarily stored or generated in a storage medium such as memory of a manufacturer server, an application store server, or a relay server.

In addition, each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before integration in the same or similar manner. Operations performed by the modules, the programs or other components according to the various embodiments may be executed in a sequential manner, a parallel manner, an iterative manner or a heuristic manner, at least some of the operations may be performed in a different order or be omitted, or other operations may be added.

As stated above, various comparative examples are described for purposes of illustration. These examples do not constitute any admissions of prior art or related art, and some or all aspects may be considered to be and/or combined with aspects of the inventive concept.

According to an aspect of the disclosure, an electronic apparatus may include at least one processor and memory storing instructions, where the instructions, when executed by the at least one processor individually or collectively, cause the electronic apparatus to obtain at least one first audio object mask corresponding to a first audio frame among a plurality of audio frames, identify at least one second audio object mask corresponding to a second audio frame that is after the first audio frame by inputting the obtained at least one first audio object mask into a first neural network model and identify at least one second audio object in the second audio frame based on the identified at least one second audio object mask.

The first neural network model may be configured to, based on at least one object mask corresponding to an audio frame in a first playback section being input into the first neural network model, output at least one object mask corresponding to an audio frame that is in a second playback section after the first playback section by using a state space model.

The electronic apparatus may include a speaker, and the instructions, when executed by the at least one processor individually or collectively, may further cause the electronic apparatus to stream an audio signal including the plurality of audio frames through the speaker in real time.

The instructions, when executed by the at least one processor individually or collectively, may further cause the electronic apparatus to perform pre-processing on the first audio frame and obtain the at least one first audio object mask by inputting the pre-processed first audio frame into a second neural network model.

The instructions, when executed by the at least one processor individually or collectively, may further cause the electronic apparatus to convert the first audio frame into information about a frequency domain, normalize the information about the frequency domain, and obtain the at least one first audio object mask by inputting the normalized information into the second neural network model.

The second neural network model may be configured to, based on a pre-processed audio frame being input into the second neural network model, output at least one object mask corresponding to each of at least one audio object in the input pre-processed audio frame, and is implemented as a U-Net structure including an encoder and a decoder.

Th instructions, when executed by the at least one processor individually or collectively, may further cause the electronic apparatus to perform pre-processing for the second audio frame, perform an operation using the pre-processed second audio frame for each of the at least one second audio object mask by multiplying the pre-processed second audio frame by each of at least one second audio object mask, and identify each of the at least one second audio object based on a result of the operation.

The instructions, when executed by the at least one processor individually or collectively, may further cause the electronic apparatus to identify the at least one second audio object mask by inputting the at least one first audio object mask into the first neural network model while the first audio frame is streamed and identify at least one third audio object mask corresponding to a third audio frame that is after the second audio frame among the plurality of audio frames by inputting the identified at least one second audio object mask into the first neural network model while the second audio frame is streamed.

The instructions, when executed by the at least one processor individually or collectively, may further cause the electronic apparatus to provide a UI including information about each of the identified at least one second audio object.

According to an aspect of the disclosure, a method of operating an electronic apparatus may include obtaining at least one first audio object mask corresponding to a first audio frame among a plurality of audio frames, identifying at least one second audio object mask corresponding to a second audio frame that is after the first audio frame, by inputting the obtained at least one first audio object mask into a first neural network model, and identifying at least one second audio object in the second audio frame based on the identified at least one second audio object mask.

The first neural network model may be configured to, based on at least one object mask corresponding to an audio frame played in a first playback section being input into the first neural network model, output at least one object mask corresponding to an audio frame that is in a second playback section after the first playback section by using a state space model.

The method may include streaming an audio signal including the plurality of audio frames in real time.

The obtaining of the at least one first audio object mask may include performing pre-processing on the first audio frame and obtaining the at least one first audio object mask by inputting the pre-processed first audio frame into a second neural network model.

The performing of the pre-processing for the first audio frame may include converting the first audio frame into information about a frequency domain, and normalizing the information about the frequency domain, where the obtaining of the at least one first audio object mask may include, obtaining the at least one first audio object mask by inputting the normalized information into the second neural network model.

According to an aspect of the disclosure, a non-transitory, computer readable storage medium may store instructions that, when executed by at least one processor of an electronic apparatus, cause the electronic apparatus to obtain at least one first audio object mask corresponding to a first audio frame among a plurality of audio frames, identify at least one second audio object mask corresponding to a second audio frame that is after the first audio frame by inputting the obtained at least one first audio object mask into a first neural network model, and identify at least one second audio object in the second audio frame based on the identified at least one second audio object mask.

The instructions, when executed by the at least one processor, may further cause the electronic apparatus to perform pre-processing on the first audio frame and obtain the at least one first audio object mask by inputting the pre-processed first audio frame into a second neural network model.

The instructions, when executed by the at least one processor, may further cause the electronic apparatus to convert the first audio frame into information about a frequency domain, normalize the information about the frequency domain, and obtain the at least one first audio object mask by inputting the normalized information into the second neural network model.

The instructions, when executed by the at least one processor, may cause the electronic apparatus to convert the first audio frame into information about the frequency domain by using an x-point FFT algorithm.

The instructions, when executed by the at least one processor, may cause the electronic apparatus to normalize the information about the frequency domain by applying PCEN to the information about the frequency domain.

The instructions, when executed by the at least one processor, may further cause the electronic apparatus to perform pre-processing for the second audio frame, multiply the pre-processed second audio frame by each of at least one second audio object mask, and identify each of the at least one second audio object based on a result of the operation.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An electronic apparatus comprising:
at least one processor; and
memory storing instructions,
wherein the instructions, when executed by the at least one processor individually or collectively, cause the electronic apparatus to:
obtain at least one first audio object mask corresponding to a first audio frame among a plurality of audio frames;
identify at least one second audio object mask corresponding to a second audio frame that is after the first audio frame by inputting the obtained at least one first audio object mask into a first neural network model; and
identify at least one second audio object in the second audio frame based on the identified at least one second audio object mask.

2. The electronic apparatus as claimed in claim 1, wherein the first neural network model is configured to, based on at least one object mask corresponding to an audio frame in a first playback section being input into the first neural network model, output at least one object mask corresponding to an audio frame that is in a second playback section after the first playback section by using a state space model.

3. The electronic apparatus as claimed in claim 1, further comprising a speaker,
wherein the instructions, when executed by the at least one processor individually or collectively, further cause the electronic apparatus to:
stream an audio signal comprising the plurality of audio frames through the speaker in real time.

4. The electronic apparatus as claimed in claim 1, wherein the instructions, when executed by the at least one processor individually or collectively, further cause the electronic apparatus to:
perform pre-processing on the first audio frame; and
obtain the at least one first audio object mask by inputting the pre-processed first audio frame into a second neural network model.

5. The electronic apparatus as claimed in claim 4, wherein the instructions, when executed by the at least one processor individually or collectively, further cause the electronic apparatus to:
convert the first audio frame into information about a frequency domain;
normalize the information about the frequency domain; and
obtain the at least one first audio object mask by inputting the normalized information into the second neural network model.

6. The electronic apparatus as claimed in claim 4, wherein the second neural network model is configured to, based on a pre-processed audio frame being input into the second neural network model, output at least one object mask corresponding to each of at least one audio object in the input pre-processed audio frame, and is implemented as a U-Net structure comprising an encoder and a decoder.

7. The electronic apparatus as claimed in claim 1, wherein the instructions, when executed by the at least one processor individually or collectively, further cause the electronic apparatus to:
perform pre-processing for the second audio frame;
perform an operation using the pre-processed second audio frame for each of the at least one second audio object mask by multiplying the pre-processed second audio frame by each of the at least one second audio object mask; and
identify each of the at least one second audio object based on a result of the operation.

8. The electronic apparatus as claimed in claim 1, wherein the instructions, when executed by the at least one processor individually or collectively, further cause the electronic apparatus to:
identify the at least one second audio object mask by inputting the at least one first audio object mask into the first neural network model while the first audio frame is streamed; and
identify at least one third audio object mask corresponding to a third audio frame that is after the second audio frame among the plurality of audio frames by inputting the identified at least one second audio object mask into the first neural network model while the second audio frame is streamed.

9. The electronic apparatus as claimed in claim 1, wherein the instructions, when executed by the at least one processor individually or collectively, further cause the electronic apparatus to:
provide a user interface (UI) comprising information about each of the identified at least one second audio object.

10. A method for operating an electronic apparatus, the method comprising:
obtaining at least one first audio object mask corresponding to a first audio frame among a plurality of audio frames;
identifying at least one second audio object mask corresponding to a second audio frame that is after the first audio frame, by inputting the obtained at least one first audio object mask into a first neural network model; and
identifying at least one second audio object in the second audio frame based on the identified at least one second audio object mask.

11. The method as claimed in claim 10, wherein the first neural network model is configured to, based on at least one object mask corresponding to an audio frame played in a first playback section being input into the first neural network model, output at least one object mask corresponding to an audio frame that is in a second playback section after the first playback section by using a state space model.

12. The method as claimed in claim 10, further comprising:
streaming an audio signal comprising the plurality of audio frames in real time.

13. The method as claimed in claim 10, wherein the obtaining of the at least one first audio object mask comprises:
performing pre-processing on the first audio frame, and
obtaining the at least one first audio object mask by inputting the pre-processed first audio frame into a second neural network model.

14. The method as claimed in claim 13, wherein the performing of the pre-processing for the first audio frame comprises:
converting the first audio frame into information about a frequency domain, and
normalizing the information about the frequency domain, and
wherein the obtaining of the at least one first audio object mask comprises, obtaining the at least one first audio object mask by inputting the normalized information into the second neural network model.

15. A non-transitory, computer readable storage medium storing instructions that, when executed by at least one processor of an electronic apparatus, cause the electronic apparatus to:
obtain at least one first audio object mask corresponding to a first audio frame among a plurality of audio frames,
identify at least one second audio object mask corresponding to a second audio frame that is after the first audio frame by inputting the obtained at least one first audio object mask into a first neural network model, and
identify at least one second audio object in the second audio frame based on the identified at least one second audio object mask.

16. The non-transitory, computer readable storage medium of claim 15, wherein the instructions, when executed by the at least one processor, further cause the electronic apparatus to:
perform pre-processing on the first audio frame; and
obtain the at least one first audio object mask by inputting the pre-processed first audio frame into a second neural network model.

17. The non-transitory, computer readable storage medium of claim 16, wherein the instructions, when executed by the at least one processor, further cause the electronic apparatus to:
convert the first audio frame into information about a frequency domain;
normalize the information about the frequency domain; and
obtain the at least one first audio object mask by inputting the normalized information into the second neural network model.

18. The non-transitory, computer readable storage medium of claim 17, wherein the instructions, when executed by the at least one processor, cause the electronic apparatus to convert the first audio frame into information about the frequency domain by using an x-point fast Fourier transform (FFT) algorithm.

19. The non-transitory, computer readable storage medium of claim 17, wherein the instructions, when executed by the at least one processor, cause the electronic apparatus to normalize the information about the frequency domain by applying per-channel energy normalization (PCEN) to the information about the frequency domain.

20. The non-transitory, computer readable storage medium of claim 15, wherein the instructions, when executed by the at least one processor, further cause the electronic apparatus to:
perform pre-processing for the second audio frame;
multiply the pre-processed second audio frame by each of the at least one second audio object mask; and
identify each of the at least one second audio object based on a result of the operation.
